(19) United States
(12) Patent Application Publication
(10) Pub. No.: US 2020/0125173 A1
(43) Pub. Date: Apr. 23, 2020

(54) FRICTION BASED KINESTHETIC ACTUATORS

(71) Applicant: IMMERSION CORPORATION, San Jose, CA (US)

(72) Inventors: Vahid KHOSHKAVA, Montreal (CA); Simon FOREST, Montreal (CA)

(21) Appl. No.: 16/164,934

(22) Filed: Oct. 19, 2018

(51) Int. Cl. G06F 3/01; A63F 13/24

(52) U.S. Cl. CPC G06F 3/016; G06F 3/0338; A63F 13/24

(57) ABSTRACT

Friction based kinesthetic actuation systems are provided. The friction based kinesthetic actuator systems include at least a friction based kinesthetic actuation device and a user interface element. One or more actuation beams, including at least a friction head and a smart material element, of the friction based kinesthetic actuation device act on the user interface element. Activation of the smart material element applies or increases a normal force between the friction head and an actuation surface of a user interface element. The normal force allows the generation or increase of a friction force between the friction heads of the actuator and the actuation surface. The friction force between the actuator and the actuation surface of the user interface element generates a kinesthetic effect at the user interface element.

### FIELD OF THE INVENTION

The present invention relates to friction based kinesthetic actuators for providing haptic feedback. In particular, embodiments hereof are directed to devices and methods having kinesthetic actuators that provide kinesthetic effects including movement, vibration, and resistance to movement.

### BACKGROUND OF THE INVENTION

Kinesthetic effects applied to user interface elements of user interface devices can enhance and enrich the user experience when interacting with such user interface devices. Such effects may be particularly advantageous in a video gaming or immersive reality (virtual reality, augmented reality, mixed/merged reality) setting for providing haptic feedback to a user. Such haptic feedback not only enhances the interaction but may be used to provide valuable information to a user. Due to the value of kinesthetic feedback in various interactive systems, new and efficient ways of providing such feedback are sought after.

The inventions described herein provide novel and different ways of generating kinesthetic effects via a user interface device in an interactive system.

### BRIEF SUMMARY OF THE INVENTION

In an embodiment, a user interface device is provided. The user interface device includes a housing; a user interface element having at least one actuation surface disposed within the housing; and a plurality of actuation beams disposed within the housing and configured to generate kinesthetic effect on the user interface element when activated via a control signal. The kinesthetic effect is provided by the plurality of actuation beams through a friction force generated between the plurality of actuation beams and the at least one actuation surface.

In another embodiment, a friction based kinesthetic actuator system configured for use with a user interface device is provided. The friction based kinesthetic actuator system includes a user interface element having at least one actuation surface disposed within a housing of the user interface device and a plurality of actuation beams disposed within the housing and configured to generate kinesthetic effect on the user interface element when activated via a control signal. The kinesthetic effect is provided by the plurality of actuation beams through a friction force generated between the plurality of actuation beams and the at least one actuation surface.

### BRIEF DESCRIPTION OF THE DRAWINGS

The foregoing and other features and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIGS. 1A and 1B illustrate a user interface device consistent with embodiments hereof.

FIG. 2 is a schematic illustration of a user interface device consistent with embodiments hereof.

FIG. 3 illustrates a friction based kinesthetic actuator system consistent with embodiments hereof.

FIG. 4A-4C illustrates example user interface elements consistent with embodiments hereof.

FIGS. 5A-5C illustrate operation of an actuation beam of a gapless friction based kinesthetic actuation device consistent with embodiments hereof.

FIGS. 6A-6C illustrate operation of an actuation beam of a non-contact friction based kinesthetic actuation device consistent with embodiments hereof.

FIG. 7 illustrates engagement of actuation beams with surfaces of a user interface element consistent with embodiments hereof.

FIGS. 8A-8C illustrate operation of an actuation beam of a friction based kinesthetic actuation device consistent with embodiments hereof.

FIG. 9 illustrates a process of generating friction based kinesthetic effects.

### DETAILED DESCRIPTION OF THE INVENTION

Specific embodiments of the present invention are now described with reference to the figures. The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Embodiments hereof include kinesthetic actuation devices configured to provide lightweight and efficient actuation to user control elements. The kinesthetic actuation devices include multiple smart material actuation beams and may be arranged with user interface or control elements to form a friction based kinesthetic actuation system.

The friction based kinesthetic actuation devices described herein may be employed to provide kinesthetic effects such as resistance to movement of a user interface element, movement of a user interface element, and vibration of a user interface element. For example, resistance to movement of a user interface element may be employed to modulate the stiffness of a user interface element to generate kinesthetic effects consistent with user experiences such as grasping objects of varying stiffness or moving objects of varying resistance, such as a stiff lock. Movement of a user interface element may be employed to provide a user with kinesthetic effects consistent with rapid action, such as a car crash or a gun shot. Vibration effects may be employed to provide a user with kinesthetic effects representative of in-game actions such as rapid shaking or driving a car across rough terrain. The foregoing are merely examples of situations where appropriate kinesthetic effects may be provided and are not intended to limit potential uses of the kinesthetic actuation devices and systems described herein.

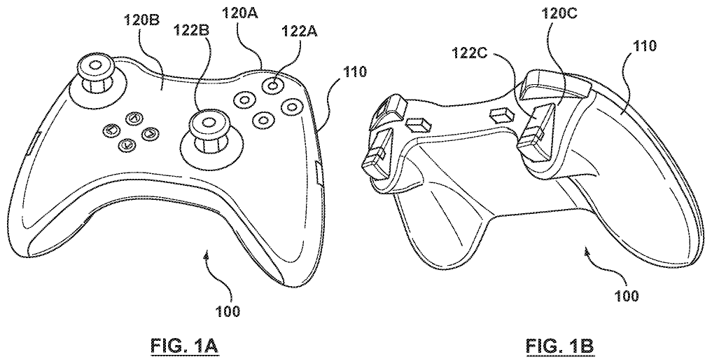

FIGS. 1A and 1B illustrate a user interface device 100 consistent with embodiments hereof. The user interface device 100 includes a housing 110 and user interface elements 120A, 120B, 120C, which are collectively and individually referred to herein as user interface element or elements 120, of which only the external portions 122A, 122B, and 122C are shown. The external portions 122A, 122B, and 122C of user interface elements 120A, 120B, 120C may include joysticks, triggers, joypads, buttons, bumpers, and any other manipulatable interface element. The user interface device 100 may be configured as a gaming controller in embodiments, as illustrated in FIG. 1A and FIG. 1B. In alternative embodiments, a user interface device suitable for use with inventions described herein may be configured in alternative forms, such as a standalone gaming device including a display screen, a gaming wand, a steering wheel, a smartphone, a tablet, a gun shaped gaming controller, and any other suitable structure. The scope of the invention and the implementation of the friction based kinesthetic actuation devices described herein are not limited to or by the user interface devices 100 that are described herein.

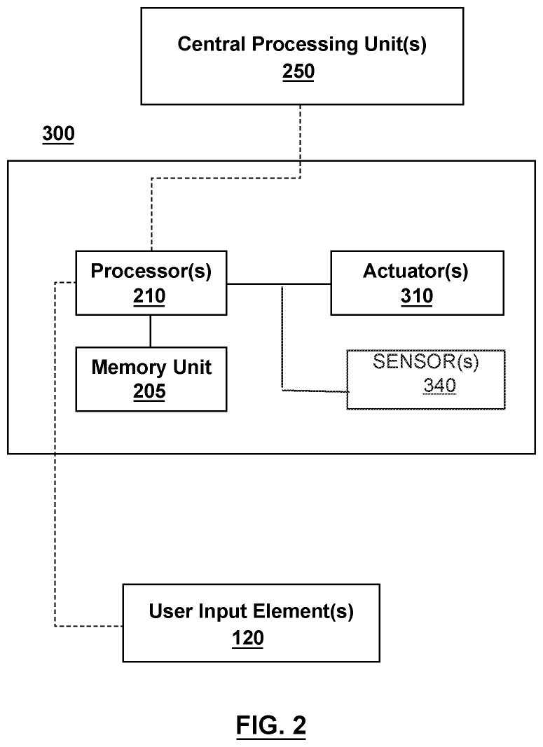

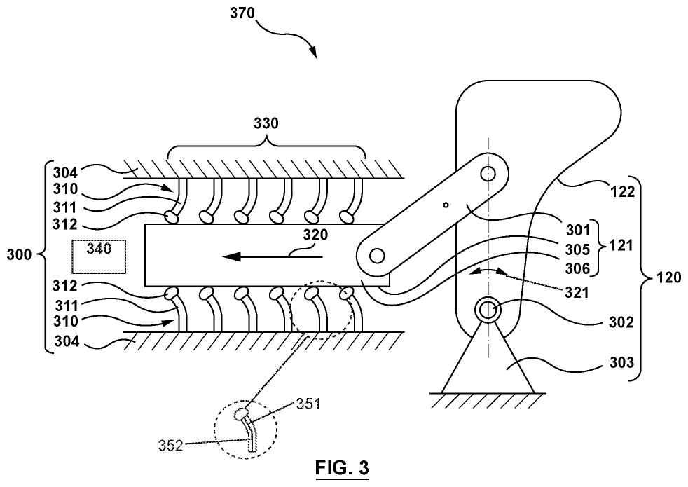

FIG. 2 is a schematic illustration of components of a friction based kinesthetic actuation device 300 consistent with embodiments hereof. The friction based kinesthetic actuation device 300 includes at least one processor 210, at least one memory unit 205, and at least one actuation beam 310. The friction based kinesthetic actuation device 300 may include additional components and features as described with respect to FIG. 3.

The processors 210 are programmed by one or more computer program instruction stored in the memory unit(s) 205. The functionality of the processor 210, as described herein, is implemented by software stored in the memory unit(s) 205 or another computer-readable or tangible medium and executed by the processor 210. As used herein, for convenience, the various instructions may be described as performing an operation, when, in fact, the various instructions program the processors 210 to perform the operation. In other embodiments, the functionality of the processor may be performed by hardware (e.g., through the use of an application specific integrated circuit (“ASIC”), a programmable gate array (“PGA”), a field programmable gate array (“FPGA”), etc.), or any combination of hardware and software.

The various instructions described herein may be stored in the memory unit(s) 205, which may comprise random access memory (RAM), read only memory (ROM), flash memory, and/or any other memory suitable for storing software instructions. The memory unit(s) 205 store the computer program instructions (e.g., the aforementioned instructions) to be executed by the processor 210 as well as data that may be manipulated by the processor 210.

The processor 210 is configured to transmit or send an activation control signal to the one or more friction based kinesthetic actuation beams 310 of the friction based kinesthetic actuation device 300. The activation control signal is configured to cause activation of the actuation beams 310, as described in greater detail below. The activation control signal is generated by the processor 210 to achieve specific effects on the user interface element 120, as described further below. The activation control signal may include multiple signals sent individually to each friction based kinesthetic actuation beam 310 or a single signal that is routed collectively to all of the friction based kinesthetic actuation beams 310. In further embodiments, the processor 210 may send different activation control signals to each friction based kinesthetic actuation beam 310.

The activation control signal is generated by the processor 210 according to parameters of a software application with which a user of the user interface device 100 is interacting. Friction based kinesthetic actuation devices consistent with embodiments hereof are configured to provide kinesthetic effects, e.g., resistance to movement, vibration, and/or movement of the user interface elements 120 of the user interface device 100. The kinesthetic effects are provided to enhance the experience of a user employing the user interface device 100 to interact with a software application, such as a game or productivity application. The processor 210 interacts with one or more central processing units 250 of a computer system running software applications with which a user is interacting. The central processing unit(s) 250 provide the processor 210 with instructions including software application parameters for producing kinesthetic effects. The processor 210 generates activation control signals based on the received instructions.

In embodiments, the processor 210 may be configured to receive user input signals from the user interface elements 120 of the user interface device 100. Such user input signals may be used, in specific embodiments, in addition to or instead of software application parameters for generating activation control signals to provide kinesthetic effects via the friction based kinesthetic actuation device 300. In embodiments, the processor 210 is further configured to generate the activation control signal at least partially in response to data or information provided by the one or more sensors 340. Sensors 340 may optionally be included in any embodiment of a friction based kinesthetic device discussed herein. Sensor(s) 340 include sensors configured to measure, determine, and/or sense a location, position, and or movement of one or more system components. The output of the sensor(s) 340 may be transmitted to and used by the processor 210 as feedback in a control system, such as a closed loop control system for controlling the friction based kinesthetic device 300. In embodiments, the sensor(s) 340 may be an aspect of the friction based kinesthetic actuator device 300. In further embodiments, the sensor(s) 340 may be disposed or provided separately from the friction based kinesthetic actuator device 300 while still being configured to transmit information to the processor 210. Further aspects of the sensor(s) 340 are discussed in greater detail below with respect to the friction based kinesthetic actuator system as illustrated in FIG. 3.

In embodiments, the processor 210 is located within the housing 110 of the user interface device 100 with other components of the friction based kinesthetic actuation device 300. The processor 210 communicates with and otherwise interacts with other systems and components in use with the user interface device 100 and supplies activation control signals to the actuation beams 310 of the friction based kinesthetic actuation device 300. In embodiments, the processor 210 is located remotely from the user interface device 100 containing the actuation beams 310 of the friction based kinesthetic actuation device 300. In such embodiments, the processor 210 supplies activation control signals to the actuation beams 310 of the friction based kinesthetic actuation device 300 while communicating with and otherwise interacting with any other components or systems in use with the user interface device 100. In embodiments, the friction based kinesthetic actuation device 300 does not include the processor 210. The processor 210 or another processor of similar capabilities may be associated with or part of another system which provides activation control signals to the friction based kinesthetic actuation device 300.

FIG. 3 illustrates a friction based kinesthetic actuator system 370 consistent with embodiments hereof. The friction based kinesthetic actuator system 370 includes the friction based kinesthetic actuation device 300 and the user interface element 120. The friction based kinesthetic actuation device 300 includes one or more actuation beams 310 configured to provide a kinesthetic effect via the user interface element 120 when activated. The kinesthetic effect may include resistance to movement, vibration, and/or movement of the user interface elements 120. Each of these effects may vary in strength according to the activation control signal provided to the friction based kinesthetic actuation devices 300. The actuation beams 310 include a smart material element 311 and a friction head 312 coupled to an actuator base 304. In embodiments, the friction based kinesthetic actuator system 370 further includes one or more sensors 340. As discussed above, the sensors 340 may be an aspect of the friction based kinesthetic actuation device 300 or may be external from the friction based kinesthetic actuation device 300.

The user interface element 120 includes at least an internal portion 121 and an external portion 122, along with any associated structures required to support the internal portion 121 and the external portion 122. The external portion 122 of the user interface element 120 is configured to be disposed at least partially on the exterior of the housing 110 (not shown in FIG. 3) for user interaction, and may be configured as a button, joystick, joypad, bumper, trigger, or other suitable interface mechanism. The external portion 122 further includes or is coupled to a pivot 302 and a pivot base 303 configured to couple the external portion 122 to the housing 110. The pivot 302 and the pivot base 303 are disposed in the interior of the housing 110. The internal portion 121 of the user interface element 120 includes an actuation rod 306 having one or more actuation surfaces 305 and one or more linkages 301. The internal portion 121 of the user interface element 120 is configured to be disposed in the interior of the housing 110. The actuation rod 306 may have various shapes, including cylindrical, rectangular prism, and or any other solid shape capable of supporting one or more actuation surfaces 305. The actuation rod 306 of the internal portion 121 is coupled to the external portion 122 via the one or more linkages 301. The linkage, as illustrated in FIG. 3, is rotationally coupled at one end to the external portion 122 and rotationally coupled at the other end to the actuation rod 306 of the internal portion 121.

The external portion 122 is configured for operation by a user. The external portion 122 is configured to cause movement of the actuation rod 306 when operated by a user. Such movement may include translation or rotation of the actuation rod 306. For example, in an embodiment where movement of the actuation rod 306 is constrained to long axis of the actuation rod 306, movement in the form of translation would occur. Constraint of the actuation rod 306 may be provided by suitable structures, such as bearings or bushings, and/or by the actuation beams 310. For example, where the actuation rod 306 is constrained, the external portion 122, when operated by a user, rotates around pivot 302 as shown by arrow 321 and, via the linkage 301, pushes the actuation rod 306 in the direction of arrow 320 to cause linear translation.

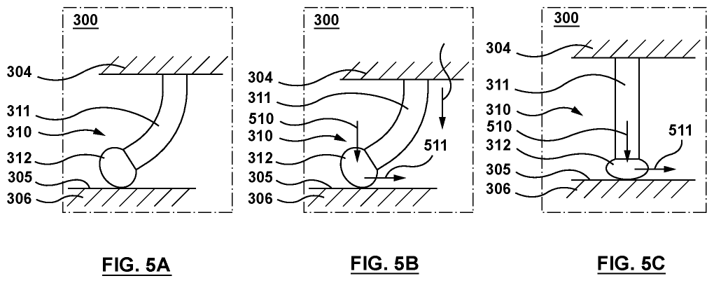

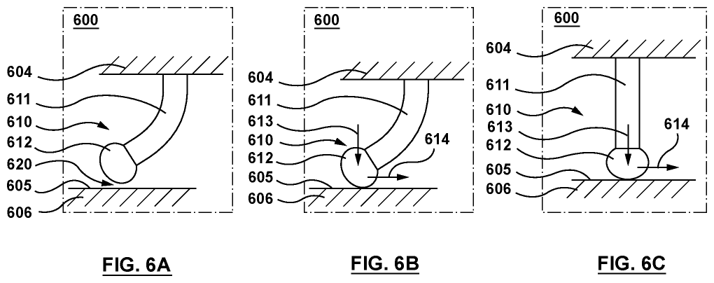

The friction based kinesthetic actuation device 300 has an inactive state and an active state. In the inactive state, i.e., when not activated by an activation control signal, the friction based kinesthetic actuation device 300 provides minimal or zero force on the external portion 122 and minimal resistance to movement of the external portion 122. In embodiments, the individual actuation beams 310 contact the actuation surface when in an inactive state but provide minimal resistance to movement of the actuation rod 306. In alternative embodiments, the individual actuation beams 310 of the friction based kinesthetic actuation device 300 do not contact the actuation surface 305. In these embodiments, when the friction based kinesthetic actuation device 300 is not activated, the user interface element 120 operates with minimal or no resistance provided by the friction based kinesthetic actuation device 300. Embodiments including contact between the inactive actuation beams 310 and the actuation surface 305 are further discussed with respect to FIGS. 5A-5C. Embodiments including no contact between the inactive actuation beams 310 and the actuation surface 305 are further discussed with respect to FIGS. 6A-6C.

In further embodiments, additional components providing force and or resistance to movement of the actuation rod 306 and/or user interface element 125 may be included. Additional components may include active and/or passive components.

Passive components include structures such as springs and dampers that do not require a power input to provide force or resistance to movement of the user interface element 120. For example, one or both of the actuation rod 306 and/or the user interface element 120 may be coupled to an elastic structure such as a spring, rubber band, or other suitable structure configured to provide resistance to movement and to return the user interface element 125 to its original position after activation by a user. In another example, the user interface element 125 may be coupled to a damping structure configured to provide resistance to movement during user activation of the user interface element 120.

Active components include structures and devices that generate force or resistance to movement of the user interface element 120 in response to a powered input, such as an activation control signal. Active components may include kinesthetic and/or haptic actuators, including, but not limited to, linear resonant actuators, shape memory actuators, piezoelectric actuators, eccentric rotating mass actuators, smart polymer actuators, and any other powered actuator suitable for use in a gaming controller.

In still further embodiments, the friction based kinesthetic actuation device 300 may be configured such that the actuation beams 310 in an inactive state contact the actuation surface 305 and provide a predetermined friction force to generate resistance to movement of the user interface element 120.

The friction based kinesthetic device 300 has an active state that is entered when an activation control signal is provided. The activation control signal causes the actuation beams 310 to provide a friction force on the actuation surface 305, and thus a resistance to movement of the actuation rod 306. The activation control signal may be increased in magnitude to cause an increase in the friction force and an increase in the resistance to movement of the actuation rod 306. The activation control signal, as discussed in greater detail below, may be varied in other ways to alter the kinesthetic effect provided by the friction based kinesthetic actuation device 300.

The one or more actuation beams 310 of the friction based kinesthetic actuation device 300 each include a smart material element 311 and a friction head 312. The friction head 312 may comprise rubber, silicone, or other material selected to generate a significant coefficient of friction between the friction head 312 and the actuation surface 305. As used herein, “significant” coefficient of friction refers to a coefficient of friction significant enough to provide an amount of friction force between the friction head 312 and the actuation surface 305 such that an appropriate kinesthetic force can be transferred to the user interface element 120 via the actuation surface 305. In alternative embodiments, the actuation beams 310 do not include friction heads 312, and the smart material element 311 itself is configured to contact the actuation surface 305.

The actuation beams 310 of the friction based kinesthetic actuation device 300 include at least a smart material element 311. The smart material elements 311 are configured to change shape when activated. In embodiments, changes in shape may include flexing or bending when activated. The flexing or bending of the smart material element 311 includes bending from a straight configuration to a bent configuration as well as bending from a bent configuration to a different bent configuration (i.e., changing the angle or arc of bending or changing the direction of bending) and/or from a bent configuration to a straight configuration. In embodiments, the actuation beam 310 may be constrained from flexing or bending when the smart material element 311 is activated. In such embodiments, activation of the smart material element 311 causes the actuation beam 310 to generate a force against the constraint preventing the flexing or bending. In further embodiments, the change in shape of the smart material elements 311 may include an elongation or contraction of the smart material element in addition to or instead of any changes in flexing or bending. For example, the smart material elements 311 may expand to provide additional normal force and/or may contract to reduce or eliminate the normal force.

The smart material element 311 is or may include an active element of a smart material, such as of a piezoelectric material, a piezoceramic material, an electroactive polymer, a shape memory material, and/or any other smart material able to flex or bend when activated by an activation signal. In embodiments, the smart material element 311 further includes an additional inactive element 351 bonded to the active element 352 to provide additional structure. The smart material element 311 may have a unimorph structure having a single active element or a bimorph structure having two active elements. In further embodiments, the smart material element 311 may have a multi-layered structure, comprising more than two layers of active elements. Multi-layered smart material elements 311 may provide increased force and/or displacement as well as reduced or decreased activation voltage.

In an embodiment, the smart material element 311 includes an active element 352 and an inactive element 351 bonded to it. The active element 352 is configured to expand or contract when entering an active state, depending upon the activation control signal applied to it. The inactive element 351 is selected such that it is resistant to expansion or contraction but able to bend laterally. When the active element 352 expands, the inactive element 351 does not, and this asymmetrical expansion causes the smart material element 311 to bend in a direction such that the smart material element 311 away from the side of the actuation beam on which the smart material element 311 is disposed. When the active element 352 contracts, the inactive element 351 does not, and this asymmetrical contraction causes the smart material element 311 to bend in the opposite direction, the direction towards the side of the actuation beam 310 on which the smart material element 311 is disposed. In further embodiments, the smart material element 311 includes two active elements 352, configured to alternately expand and contract to cause bending in the smart material element 311.

The actuation beams 310 are disposed such that the friction heads 312 contact the actuation surface or surfaces 305 when the actuation beams 310 are in an inactive state. In the inactive state, the friction heads 312 contact the actuation surface 305 but do not apply a significant amount of force to the actuation surface 305. That is, the normal force, or force applied perpendicular to the actuation surface(s) 305, is low. Because the normal force between the friction heads 312 and the actuation surface(s) 305 is low, any friction force generated by the normal force between the friction heads 312 and the actuation surface(s) 305 is also low. The friction force is a function of the normal force and the coefficient of friction between the actuation surface(s) 305 and the friction heads 312.

When the actuation beams 310 are activated via an activation control signal, they provide force on the actuation surface(s) 305 and thus on the actuation rod 306. The force provided may have two vector components, a normal force perpendicular to the actuation surface(s) 305 and a friction force parallel to the actuation surface(s) 305. The friction force is generated by the normal force in opposition or resistance to attempted relative movement between the actuation surface(s) 305 and the friction heads 312. The friction force may be static friction for situations where the actuation surface(s) 305 and the friction heads 312 exert force on one another but do not move relative to one another. The friction force may be dynamic friction for situations where the actuation surface(s) 305 and the friction heads 312 move relative to one another. The friction force may also be a combination of dynamic friction and static friction where movement between the actuation surface(s) 305 and the friction heads 312 is not smooth. The friction force may generate movement of the user interface element 120 and/or may resist movement of the user interface element 120.

Application of the normal force permits the generation of the friction force. The friction force is not generated, however, without an attempt at relative movement between the actuation surface(s) 305 and the friction heads 312. The attempt at relative movement may be provided by a user moving the user interface element, by activation of the actuation beams to move the user interface element, and/or by a combination of both.

The structure and materials of the actuation beams 310, as well as the geometry of the actuation beams 310 with respect to the actuation surface(s) 305 influences the magnitude of each of these forces. In the embodiment of FIG. 3, the actuation beams 310 are configured such that, when activated, substantially all of the force imparted to the actuation surface(s) 305 is normal force. That is, no friction force is generated until a user attempts to activate the user interface element 120. In further embodiments, e.g., as discussed below with respect to FIGS. 5A-6C, friction force is generated to cause movement of the user interface element 120.

When the actuation beams 310 are activated via the activation control signal, they provide a kinesthetic effect via a friction force causing resistance to movement of the user interface element 120. When each actuation beam 310 enters an active state, the smart material element 311 generates a force tending to straighten the actuation beam 310. In the kinesthetic actuator system 370, the actuation beams 310 are disposed such that, when in an active state, normal force is applied by the friction heads 312 to the actuation surface(s) 305 but no friction force is applied until and unless a user operates the user interface element 120. The actuation beams 310 of the friction based kinesthetic actuator system 370 are generally constrained from significant bending and thus the actuation beams 310 and friction heads 312 experience little movement during activation. Instead, the activation of the smart material element 311 acts to press the friction head 312 into the actuation surface 305 of the actuation rod 306. Pressing the friction head 312 into the actuation surface 305 increases the normal force applied to the actuation surface 305 by the friction head 312. The increased normal force, in turn, increases the friction force between the friction head 312 and the actuation surface(s) 305 that can be applied when a user operates the user interface element 120. When the user interface element 120 is operated, the increased friction force permitted by the increased normal force serves to provide resistance to movement of the actuation rod 306 and therefore resistance to movement of the external portion 122 of the user interface element 120.

Resistance may be provided based on the actuation surface 305 sliding against the friction heads 312. The normal force generated by the activated smart material elements 311 creates a dynamic friction force that resists movement of the actuation rod 306. Resistance may also be provided by the stiffness of the actuation beams 310. Where the static friction force generated by the friction heads 312 is great enough, movement of the actuation surface 305 will cause the friction heads 312 to move in concert with the actuation surface 305 motion to thereby impede or impinge upon movement of the actuation rod. Such movement, in turn, causes movement of the smart material elements 311. In this case, the stiffness of the smart material elements 311, as generated by their activation, serves to resist movement of the user interface element 120. In embodiments, both the sliding resistance provided by the friction heads 312 and the bending resistance provided by the smart material elements 311 resist movement of the actuation rod 306.

In embodiments, the activation control signal activating the actuation beam 310 may be adjusted to increase or decrease the normal force on the actuation surface 305 by inducing greater or lesser force in the smart material element 311, which permits the processor 210 to control the resistance to movement of the user interface element 120. For example, increasing the magnitude of the activation control signal serves to increase the normal force, while decreasing the magnitude of the activation control signal serves to decrease the normal force. The activation control signal may include multiple activation control signals sent by the processor 210 and received individually by each actuation beam 310 of the friction based kinesthetic actuation device 300 and/or may be a single activation control signal sent by the processor 210 and routed to the individual actuation beams 310.

If an actuation beam 310 were disposed such that the friction head 312 is free to move without constraint, the actuation beam 310 may be activated to cause the actuation beam 310 to straighten or to bend in either direction, depending on the activation control signal received. In the friction based kinesthetic actuator system 370, however, the actuation beam 310 is disposed such that the friction head 312 contacts the actuation surface 305. In embodiments, depending on the arrangement of the actuation beams 310 with respect to the actuation surface 305, activation of the actuation beam 310 may result in full straightening, incomplete straightening, or minimal movement of the smart material element 311. In embodiments, both the friction head 312 and the actuation surface 305 are substantially rigid. In such an embodiment, activation of the smart material element 311 generates force in the smart material element 311 that presses the friction head 312 into the actuation surface, creating an increase in normal force perpendicular to the actuation surface 305. Because both the smart material element 311 and the friction head 312 are substantially rigid, there is minimal straightening of the smart material element 311 while the normal force is increased due to activation of the smart material element 311. In further embodiments, one or both of the friction head 312 and the actuation surface 305 are substantially flexible. In such embodiments, activation of the actuation beam 310 may result in full or incomplete straightening of the smart material element 311 while increasing the normal force. That is, as the smart material element 311 is activated, the force provided by the smart material element 311 causes strain in the flexible friction head 312 and/or the actuation surface 305, which permits the smart material element 311 to straighten.

In embodiments, the friction based kinesthetic actuation system 370 uses the output of the one or more sensor(s) 340 as an input in control of the friction based kinesthetic actuation device 300. The sensor(s) 340 may be configured to detect position, location, and/or movement (i.e., displacement, vibration, acceleration, etc.) of any moving component of the friction based kinesthetic actuation system 370, including, for example, the user interface element 120, the external portion 122 of the user interface element 120, the actuation rod 306 or any of its actuation surfaces 305, the actuation beams 310, and/or any other component of the system, as well as any components associated with the system that are not explicitly described herein. The sensor(s) 340 may include contact sensors such as piezoelectric sensor and other contact based sensors as well as non-contact sensors such as hall effect sensors, optical sensors, eddy current sensors, and others. The sensor(s) 340 may further include motion based sensors such as accelerometers. In some embodiments, the actuation beams 310 themselves may act as the sensor(s) 340 based on the voltage response of the smart material elements 311 when subject to various forces. The sensor(s) 340 are configured to transmit or otherwise send information about the location, position, and/or movement of system components so as to provide feedback to the processor 210. The sensor(s) 340 are configured to be disposed in any suitable location with respect to the components of the friction based kinesthetic actuation system 370 that are being measured.

The processor 210 is configured to implement closed loop control of the friction based kinesthetic actuator device 300 based on the information received from the sensor(s) 340. In an example, the processor 210 may implement closed loop control to cause the user interface element 120 to output a specific kinesthetic effect to the user via the external portion 122. Sensor data about the location and/or acceleration of the actuation rod 306 and/or any other system component is used by the processor 210 to implement the closed loop control. In another embodiment, the processor 210 is configured to implement closed loop control of the friction based kinesthetic actuator device 300 to maintain the user interface element 120 in a specific position. As the user applies force to the user interface element 120 causing it to move, the closed loop control of the processor 210 causes the actuation beams 310 to apply increased friction force to the actuation surfaces 305 to counteract the user's pressure on the user interface element 120. As the user continues to increase the pressure, the processor 210, in response, increases the friction force opposing the user's pressure.

In further embodiments, activation of the actuation beams 310 via the activation control signal provides a kinesthetic movement effect to the user interface element. Such embodiments are described in greater detail below, with respect to FIGS. 5A-6C. The kinesthetic movement effect is provided via a friction force that causes movement of the user interface element 120. In such an embodiment, the actuation beams 310 are positioned such that activation of the actuation beams 310 causes the actuation beams 310 to impart a friction force on the actuation surface 305. In such embodiments, the actuation beams 310 are arranged with respect to the actuation surface 305 such that the actuation beams 310 are able to straighten, creating linear movement of the friction heads 312. After activation, the actuation beams 310 begin to straighten, pressing the friction heads 312 into the actuation surface 305 and generating normal force. The actuation beams 310 then continue to straighten, applying friction force to the actuation surface 305 via the generated normal force. As the actuation beams 310 continue to straighten, the friction heads 312 travel linearly, causing the actuation rod 306 to translate linearly. Thus, activation of the actuation beams 310 can cause linear movement of the actuation rod 306 and, via the linkage 301, movement of the external portion 122 of the user interface element 120. The magnitude of the activation control signal may be varied to adjust the speed of movement induced on the user interface element 120.

In embodiments, activation of the actuation beams 310 via the activation control signal causes a vibration-based kinesthetic effect at the user interface element 120. The actuation beams 310 act on the user interface element 120 through the actuation surface 305 of the actuation rod 306. The activation control signal may be provided as an oscillating signal, causing the actuation beams 310 to oscillate or vibrate. Such oscillation induces a vibration effect on the user interface element 120. The magnitude and frequency of the induced vibrations may be varied by variation of the magnitude and frequency of the activation control signal. In embodiments, an activation control signal having multiple frequencies may be provided by the processor 210 to the actuation beams 310, thus producing a high definition vibrotactile effect.

In embodiments, the actuation beams 310 may be activated by an activation control signal to provide any combination of the above described kinesthetic effects simultaneously. For example, the user interface element 120 may be subject to a friction force causing it to move while simultaneously vibrating. In another example, activation of the actuation beams 310 may provide resistance to movement of the user interface element 120 while simultaneously vibrating the user interface element 120.

The actuation beams 310 are configured in at least one actuator row 330 disposed along the actuation surface 305. Although FIG. 3 illustrates an embodiment including two actuator rows 330, other embodiments may include one actuator row 330 or any number of actuator rows 330 according to the number of actuation surfaces 305 and space available. In embodiments, multiple actuator rows 330 may be arranged to contact actuation surfaces 305 on opposing sides of the actuation rod 306 such that the normal forces provided by the several actuation beams 310 of each row are in opposition. For example, two actuator rows 330 may be arranged on opposite sides of an actuation rod 306 such that the normal forces applied by each actuator row 330 substantially cancel each other out, resulting in minimal net perpendicular forces on the actuation rod 306. This arrangement is illustrated in FIG. 3. Because the normal forces oppose each other, minimal net perpendicular forces are imparted on the actuation rod 306. Such an arrangement may place less stress or strain on other components of the friction based kinesthetic actuator system 370, such as any bearings or other structures supporting the actuation rod 306. In other example, three actuator rows 330 may be arranged at points 120 degrees around an actuation rod 306 such that the normal forces applied by each actuator row 330 substantially cancel each other out, resulting in minimal net forces on the actuation rod 306. In further embodiments, four or more actuator rows 330 may be arranged such that the applied normal forces substantially cancel each other out. In further embodiments, multiple actuator rows 330 may be arranged such that the normal forces are not balanced out, and the actuator rod 306 may be supported by any appropriate structures.

Although illustrated in FIG. 3 as a trigger, the external portion 122 of the user interface element 120 may also be implemented as any other suitable user interactive interface element, including buttons, bumpers, joysticks, joypads, and others. Irrespective of the implementation of the external portion 122, the user interface element 120 is configured such that user activation of the user interface element 120 via the external portion 122 causes movement of an actuation surface 305 with respect to actuation beams 310. Such movement of the actuation surface 305 includes linear translation movement, rotational movement, or both. In various embodiments, actuation rod 306 may be replaced by an alternative structure, such as a sphere, a cube, a solid polyhedron, or other shape. In various embodiments, linkage 301, pivot 302, and pivot base 303 may or may not be included, depending on the requirements of the structure. In various embodiments, the linkage 301 may be rotationally coupled to the external portion 122 at one end and rigidly coupled to the internal portion 121 at the other end, may be rotationally coupled to the internal portion 121 at one end and rigidly coupled to the external portion 122 at the other end, and may be rigidly coupled at one end to the external portion 122 and rigidly coupled to the internal portion 121 at the other end. All features of various embodiments and implementations of the user interface element 120 may be combined in different ways without departing from the scope of the invention.

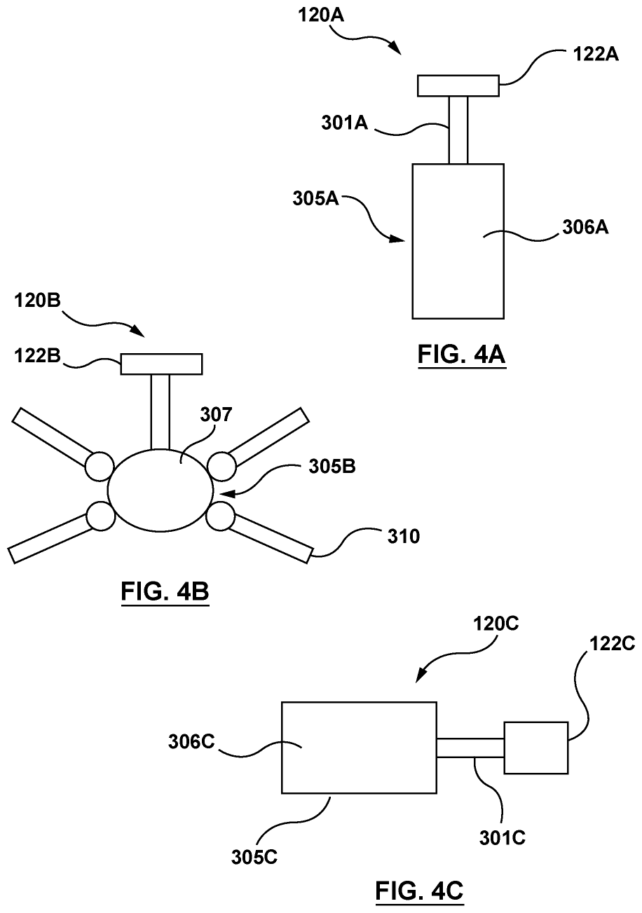

FIGS. 4A-4C illustrate several alternative implementations of the external portions of various user interface elements. FIG. 4A illustrates user interface element 120A as implemented by an external portion 122A configured as a button. User interface element 120A includes a linkage 301A, an actuation rod 306A, and an actuation surface 305A and operates substantially similarly to user interface element 120 as described with respect to FIG. 3, when operated as part of a friction based kinesthetic actuator system with the friction based kinesthetic actuation device 300. FIG. 4B illustrates user interface element 120B as implemented by an external portion 122B configured as a joystick. In user interface element 120B, the external portion 122B is directly coupled to an actuation sphere 307 having a curved actuation surface 305B. The actuation beams 310 of friction based kinesthetic actuation device 300 are arranged around the actuation sphere 307, and the system including the user interface element 120B and the friction based kinesthetic actuation device 300 operates substantially similarly to user interface element 120 and the friction based kinesthetic actuation device 300 as described with respect to FIG. 3, when operated as part of a friction based kinesthetic actuator system with the friction based kinesthetic actuation device 300. FIG. 4C illustrates user interface element 120C as implemented by an external portion 122C configured as a bumper. User interface element 120C includes a linkage 301C rigidly coupled at both ends, an actuation rod 306C, and an actuation surface 305C and operates substantially similarly to user interface element 120 as described with respect to FIG. 3, when operated as part of a friction based kinesthetic actuator system with the friction based kinesthetic actuation device 300.

FIGS. 5A-5C illustrate operation of the gapless friction based kinesthetic actuation device 300 to provide a kinesthetic movement effect consistent with embodiments hereof. As in FIG. 3, an actuation beam 310, having a friction head 312 and a smart material element 310 extends from an actuator base 304. The friction head 312 contacts the actuation surface 305 when not activated, as shown in FIG. 5A. FIG. 5B illustrates an initial stage of straightening of the actuator beam 310. When activated by a control signal, the smart material element 311 exerts a force tending to straighten the smart material element 311 and the actuation beam 310. The straightening force causes an increase in the normal force, designated by arrow 510, between the friction head 312 and the actuation surface 305. The increased normal force causes friction between the friction head 312 and the actuation surface 305. The friction between the friction head 312 and the actuation surface 305 permits the friction head 312 to impart a friction force to the actuation surface 305, designated by arrow 511. The friction force causes the actuation rod 306 to move in the direction of the arrow 511. Thus, when the actuation beam 310 straightens, as illustrated in FIG. 5C, the actuation rod 306 moves with the friction head 312 in the direction of the straightening. Accordingly, activation of the actuation beam 310 causes both normal force and friction force between the friction head 312 and the actuation surface 305. The normal force generates friction that resists relative movement between the actuation surface 305 and the friction head 312. The friction can be used to impart movement to the actuation surface 305. The friction force can thus be used to cause a kinesthetic effect in the user interface element 120 (not shown), including resistance to movement, generation of movement, and vibration.

FIGS. 6A-6C illustrate the operation of a gapped friction based kinesthetic actuation device 600 to provide a kinesthetic movement effect consistent with embodiments hereof. The friction based kinesthetic actuation device 600 includes an actuator 610 comprising a smart material element 611 and a friction head 612. FIG. 6A shows the actuator beam 610 in an inactive state. In the inactive state, the friction head 612 of the actuator beam 610 does not contact the actuation surface 605 when not activated and there is a gap 620 between the friction head 612 and the actuation surface 605. When activated by a control signal, the smart material element 611 exerts a force tending to straighten the smart material element 611. At an initial stage of activation, the straightening force causes the friction head 612 to contact the actuation surface 605 and generate a normal force between the friction head 612 and the actuation surface 605, as illustrated in FIG. 6B. The normal force is designated by arrow 613. The normal force between the actuation surface 605 and the friction head 612, generates friction, which permits the friction head 612 to impart movement, designated by arrow 614, to the actuation surface 605. The friction force causes movement of the actuation rod 606 in the direction of the arrow 614, as shown in FIG. 6C. Accordingly, activation of the actuation beam 610 causes both normal force and friction force between the friction head 612 and the actuation surface 605. The normal force generates friction that resists relative movement between the actuation surface 605 and the friction head 612. The friction can be used to impart a friction force to the actuation surface 605. The friction force can thus be used to cause a kinesthetic effect in the user interface element 120 (not shown), including resistance to movement, generation of movement, and vibration. All further features and operations of the friction based kinesthetic actuation device 600 are consistent with the operations and features of friction based kinesthetic actuation device 300 as described above.

FIGS. 5A-5C and 6A-6C illustrated embodiments wherein the friction heads 312, 612 cause movement of the actuation rods 306, 606 upon straightening. The embodiments of FIGS. 5A-5C and 6A-6C differ in that the friction based kinesthetic actuation device 600 includes the gap 620 between the friction head 612 and the actuation surface 605. These variations, e.g., having a gap and not having a gap, may be applied to any combination of embodiments discussed herein, including those having various numbers of actuation surfaces, various embodiments of a user interface element, as well as those configured to impart varying amounts of normal and friction forces.

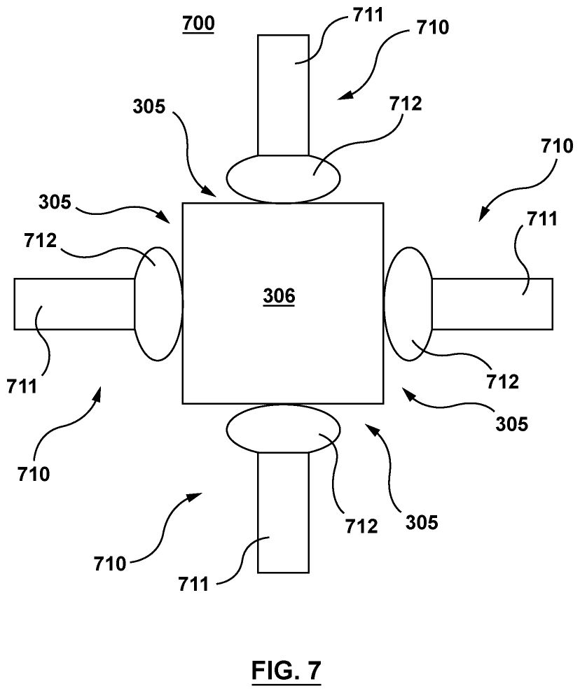

FIG. 7 illustrates an embodiment of a friction based kinesthetic actuation device 700 configured to contact multiple actuation surfaces 305 of the actuation rod 306. FIG. 7 provides a cross-sectional view of a friction based kinesthetic actuation device 700 similar to the friction based kinesthetic actuation device 300 of FIG. 3. Friction based kinesthetic actuation device 700 includes a plurality of actuators 710 arranged on four sides of the actuation rod 306. Each of the actuators 710 includes a smart material element 711 and a friction head 712 and operates substantially similarly to the actuators 310 as described with respect to FIG. 3. The actuators 710 are arranged around the circumference of the actuation rod 306, with additional actuators 710 to contact actuation surfaces 305 of the actuation rod 306. This may permit greater resistance to movement of the actuation rod 306 and/or a shorter length of the actuation rod 306. Embodiments are not limited to actuators 710 on four sides of the actuation rod 306. In an embodiment, the actuation rod 306 is cylindrical having a single curved actuation surface 305 and a ring of actuators 710 surrounding the circumference of the cylindrical actuation rod includes as many actuators as are able to fit. In other embodiments, the actuation rod 306 has 5, 6, 7, 8, 9, 10 or any other number of faces, each of which constitutes an actuation surface 305.

Described above are methods and devices for providing resistance to user activation of a user interface element 120. In further embodiments, alternative or enhanced actuation effects may be provided. Such effects may include, for example, vibration effects and movement effects.

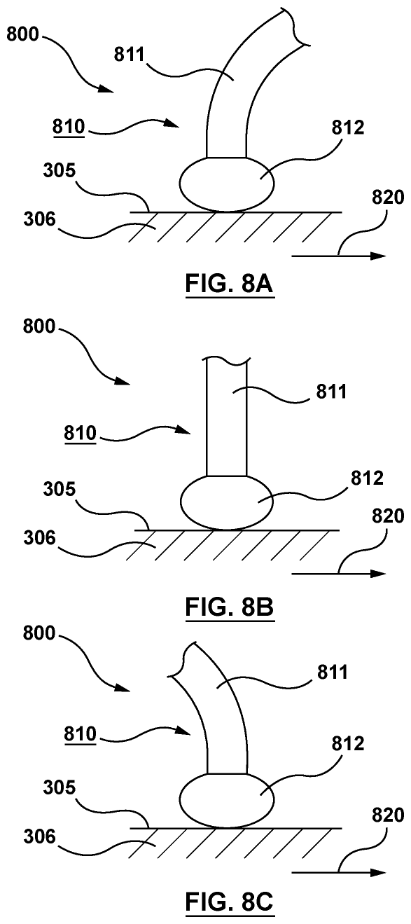

FIGS. 8A-8C illustrate operation of an actuator 810 of a friction based kinesthetic actuation device 800 consistent with embodiments hereof. The friction based kinesthetic actuation device 800 is configured to provide enhanced movement to the user interface element 120. The actuator 810 includes a bipolar smart material element 811. The bipolar smart material element 811 is capable of bending from a first bent configuration, as shown in FIG. 8A, past a straight configuration as shown in FIG. 8B, into a second bent configuration in an opposite direction of the first bent configuration, as illustrated in FIG. 8C. FIG. 8A illustrates the actuator 810 in an inactivated position, with the smart material element 811 in a first bent configuration and the friction head 812 in contact with the actuation surface 305. When the actuator 810 is activated, the smart material element 811 straightens and causes movement of the friction head 812. Where static friction between the friction head 812 and the actuation surface 305 is sufficient to prevent relative movement between the friction head and actuation surface, movement of the activated actuation beams 810 causes movement of the actuation rod 306 in the direction of arrow 820. FIG. 8B illustrates the actuator 810 in an activated position after the actuation rod 306 has been moved. Movement of the bipolar smart material element 811 into the second bent configuration causes additional movement of the actuation rod 306. In further embodiments, friction based kinesthetic actuation device 800, configured to provide movement of the actuation rod 306, may incorporate any of the feature variations previously described herein, including alternative shapes for actuation rod 306, alternative numbers of actuators 810, alternative spacing between the friction heads 812 and the actuation surface 305, and any other embodiment variations discussed herein.

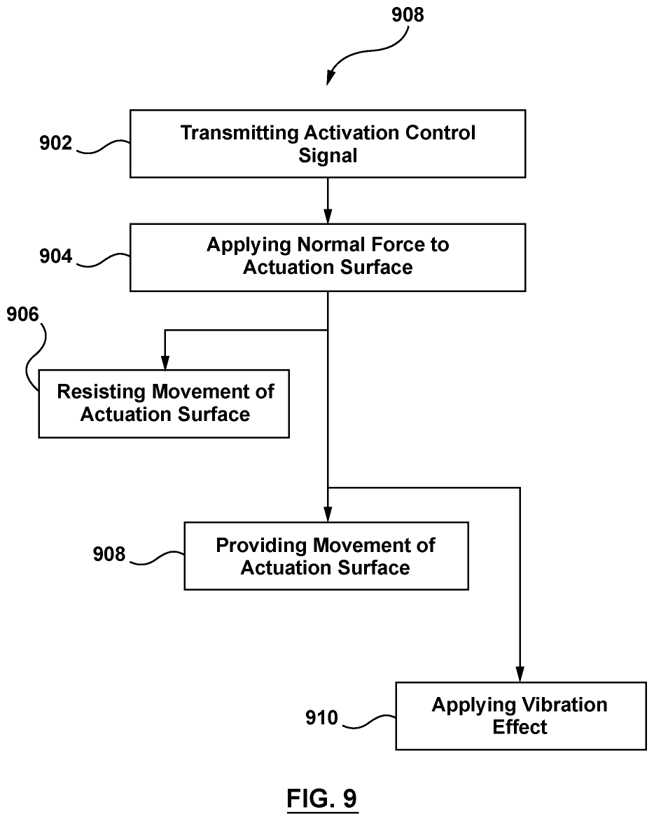

FIG. 9 is a flow diagram illustrating a kinesthetic actuation process 900 of providing kinesthetic actuation to a user interface element via a friction based kinesthetic actuation device. The process 900 may be performed via any of the friction based kinesthetic actuation device described herein using any combination of features, as may be required for the various operations of the process. The friction based kinesthetic actuation devices used by the process 900 include one or more actuation beams comprising a smart material element and a friction head. The kinesthetic actuation process 900 may be carried out with more or fewer of the described operations, in any order

In an operation 902, the kinesthetic actuation process 900 includes transmitting an activation control signal to the friction based kinesthetic actuation device. A processor or processors associated with the friction based kinesthetic actuation device generates and transmits, via appropriate circuitry, one or more activation control signals to the friction based kinesthetic actuation device. The activation control signal may include multiple activation control signals sent by the processor and received by each actuation beam of the friction based kinesthetic actuation devices individually and/or may be a single activation control signal sent by the processor and routed to the individual kinesthetic actuators. The activation control signal or signals generated by the processor are generated to cause a specific effect, e.g., movement, resistance to movement, and/or vibration, at a specific intensity level. Activation control signals may also be configured to provide a combination of multiple kinesthetic effects.

In an operation 904, the kinesthetic actuation process 900 includes applying or increasing a normal force to an actuation surface of a user interface element in response to the activation control signal. Force between friction heads of the actuators of the friction based kinesthetic actuation device and an actuation surface of the user interface element is required to cause kinesthetic effects on the user interface element. At the outset of the kinesthetic effect, whether it be movement, resistance to movement, and/or vibration, normal force between the friction heads and the actuation surface is generated.

In an operation 906, the kinesthetic actuation process 900 includes resisting movement of the actuation surface of the user interface element through a friction force generated in response to the activation control signal. A kinesthetic effect may include resisting movement of the user interface element. Normal force between the friction heads of the actuators and the actuation surface of the user interface element generates friction between the two. A user's attempt to activate the user interface element is thus resisted by either or both of friction as the actuation surface slides against the friction heads and bending resistance of the smart material element. The friction may be increased or decreased according to a magnitude of the activation control signal activating the actuation beam to increase or decrease the normal force between the friction heads and the actuation surface. The bending resistance may likewise be increased or decreased according to a magnitude of the activation control signal activating the smart material element of the actuation beams to generate greater or lesser force. Varying the intensity of the actuation control signal varies the magnitude of resistance to movement.

In an operation 908, the kinesthetic actuation process 900 includes providing movement of the actuation surface, and thus, the user interface element, by applying friction force to the actuation surface in response to the activation control signal. Activation of the actuators causes an increase in the normal force between the friction heads and the actuation surface, which increases the friction between the two. The friction force is applied to the actuation surface by activating the actuators to continue bending, thus moving the friction heads in the direction that friction force is desired. Due to the friction between the friction heads and the actuation surface, the actuation surface moves in concert with the friction heads. Varying the frequency or magnitude of the activation control signal varies the rate of movement of the actuation surface.

In an operation 910, the kinesthetic actuation process 900 includes applying a vibration effect to the user interface element through a friction force generated in response to an oscillating activation control signal. The oscillating activation control signal causes the actuators to vibrate, which imparts a vibratory effect on the user interface element via the actuation control surface. Alterations in the magnitude and frequency of the activation control signal serve to alter the magnitude and frequency of vibrations.

The above describes an illustrative flow of an example process 900 of providing a friction based kinesthetic effect. The process as illustrated in FIG. 9 is exemplary only, and variations exist without departing from the scope of the embodiments disclosed herein. The steps may be performed in a different order than that described, additional steps may be performed, and/or fewer steps may be performed.

### Additional Discussion of Various Embodiments

Embodiment 1 is a user interface device comprising:
a housing;
a user interface element having at least one actuation surface disposed within the housing; and
a plurality of actuation beams disposed within the housing and configured to generate a kinesthetic effect on the user interface element when activated via a control signal;
wherein the kinesthetic effect is provided by the plurality of actuation beams through a friction force generated between the plurality of actuation beams and the at least one actuation surface.

Embodiment 2 is the user interface device of embodiment 1, wherein each actuation beam of the plurality of actuation beams comprises a smart material element and a friction head configured to contact the at least one actuation surface.

Embodiment 3 is the user interface device of embodiments 1 or 2, wherein when the plurality of actuation beams are in an inactive state they are configured to not contact the at least one actuation surface, and wherein when the plurality of actuation beams are activated they are configured to provide a normal force against the at least one actuation surface, wherein the normal force generates the friction force.

Embodiment 4 is the user interface device of embodiments 1 or 2, wherein when the plurality of actuation beams are in an inactive state they are configured to contact the at least one actuation surface, and wherein when the plurality of actuation beams are activated they are configured to provide an increased normal force against the at least one actuation surface relative to the normal force provide when the plurality of actuation beams are in an inactive state, wherein the increased normal force generates the friction force.

Embodiment 5 is the user interface device of any of embodiments 1 through 4, wherein the plurality of actuation beams are configured to contact a plurality of actuation surfaces of an internal portion of the user interface element.

Embodiment 6 is the user interface device of any of embodiments 1 through 5, wherein the kinesthetic effect includes the friction force resisting movement of the user interface element.

Embodiment 7 is the user interface device of any of embodiments 1 through 6, wherein the kinesthetic effect includes a vibration effect.

Embodiment 8 is the user interface device of any of embodiments 1 through 7, wherein the kinesthetic effect includes the friction force generating movement of the user interface element.

Embodiment 9 is the user interface device of any of embodiments 1 through 8, wherein the user interface element includes an internal portion located interior to the housing and an external portion located exterior to the housing with the internal portion and the external portion being connected via a coupling.

Embodiment 10 is the user interface device of any of embodiments 1 through 9, wherein the external portion of the user interface element includes at least one of a joystick, a trigger, and a button.

Embodiment 11 is a friction based kinesthetic actuator system configured for use with a user interface device, comprising:
a user interface element having at least one actuation surface disposed within a housing of the user interface device; and
a plurality of actuation beams disposed within the housing and configured to generate a kinesthetic effect on the user interface element when activated via a control signal;
wherein the kinesthetic effect is provided by the plurality of actuation beams through a friction force generated between the plurality of actuation beams and the at least one actuation surface.

Embodiment 12 is the friction based kinesthetic actuator system of embodiment 11, wherein each actuation beam of the plurality of actuation beams comprises a smart material element and a friction head configured to contact the at least one actuation surface.

Embodiment 13 is the friction based kinesthetic actuator system of embodiments 11 or 12, wherein when the plurality of actuation beams are in an inactive state they are configured to not make contact with the at least one actuation surface, and wherein when the plurality of actuation beams are activated they are configured to provide a normal force against the at least one actuation surface, wherein the normal force generates the friction force.

Embodiment 14 is the friction based kinesthetic actuator system of embodiments 11 or 12, wherein when the plurality of actuation beams are in an inactive state they are configured to contact the at least one actuation surface, and wherein when the plurality of actuation beams are activated they are configured to provide an increased normal force against the at least one actuation surface relative to the normal force provide when the plurality of actuation beams are in an inactive state, wherein the increased normal force generates the friction force.

Embodiment 15 is the friction based kinesthetic actuator system of any of embodiments 11 through 14, wherein the plurality of actuation beams are configured to contact a plurality of actuation surfaces of an internal portion of the user interface element.

Embodiment 16 is the friction based kinesthetic actuator system of any of embodiments 11 through 15, wherein the kinesthetic effect includes the friction force resisting movement of the user interface element.

Embodiment 17 is the friction based kinesthetic actuator system of any of embodiments 11 through 16, wherein the kinesthetic effect includes a vibration effect.

Embodiment 18 is the friction based kinesthetic actuator system of any of embodiments 11 through 17, wherein the kinesthetic effect includes the friction force generating movement of the user interface element.

Embodiment 19 is the friction based kinesthetic actuator system of any of embodiments 11 through 18, wherein the user interface element includes an internal portion, having the at least one activation surface, that is configured for location interior to the housing of the user interface device, and includes an external portion configured for location exterior to the housing of the user interface device, wherein the internal portion and the external portion are connected via a linkage.

Embodiment 20 is the friction based kinesthetic actuator system of embodiment 19, wherein the external portion of the user interface element includes at least one of a joystick, a trigger, and a button.

Thus, there are provided systems, devices, and methods for providing friction based kinesthetic effects. While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment. Aspects of the above methods of generating kinesthetic effects may be used in any combination with other methods described herein or the methods can be used separately. All patents and publications discussed herein are incorporated by reference herein in their entirety.

What is claimed is:

1. A user interface device comprising:
a housing;
a user interface element having at least one actuation surface disposed within the housing; and
a plurality of actuation beams disposed within the housing and configured to generate a kinesthetic effect on the user interface element when activated via a control signal,
wherein the kinesthetic effect is provided by the plurality of actuation beams through a friction force generated between the plurality of actuation beams and the at least one actuation surface.

2. The user interface device of claim 1, wherein each actuation beam of the plurality of actuation beams comprises a smart material element and a friction head configured to contact the at least one actuation surface.

3. The user interface device of claim 1, wherein when the plurality of actuation beams are in an inactive state they are configured to not contact the at least one actuation surface, and wherein when the plurality of actuation beams are activated they are configured to provide a normal force against the at least one actuation surface, wherein the normal force generates the friction force.

4. The user interface device of claim 1, wherein when the plurality of actuation beams are in an inactive state they are configured to contact the at least one actuation surface, and wherein when the plurality of actuation beams are activated they are configured to provide an increased normal force against the at least one actuation surface relative to the normal force provide when the plurality of actuation beams are in an inactive state, wherein the increased normal force generates the friction force.

5. The user interface device of claim 1, wherein the plurality of actuation beams are configured to contact a plurality of actuation surfaces of an internal portion of the user interface element.

6. The user interface device of claim 1, wherein the kinesthetic effect includes the friction force resisting movement of the user interface element.

7. The user interface device of claim 1, wherein the kinesthetic effect includes a vibration effect.

8. The user interface device of claim 8, wherein the kinesthetic effect includes the friction force generating movement of the user interface element.

9. The user interface device of claim 1, wherein the user interface element includes an internal portion located interior to the housing and an external portion located exterior to the housing with the internal portion and the external portion being connected via a linkage and the at least one actuation surface being disposed on the internal portion.

10. The user interface device of claim 9, wherein the external portion of the user interface element includes at least one of a joystick, a trigger, and a button.

11. A friction based kinesthetic actuator system configured for use with a user interface device, comprising:
a user interface element having at least one actuation surface disposed within a housing of the user interface device; and
a plurality of actuation beams disposed within the housing and configured to generate a kinesthetic effect on the user interface element when activated via a control signal,
wherein the kinesthetic effect is provided by the plurality of actuation beams through a friction force generated between the plurality of actuation beams and the at least one actuation surface.

12. The friction based kinesthetic actuator system of claim 11, wherein each actuation beam of the plurality of actuation beams comprises a smart material element and a friction head configured to contact the at least one actuation surface.

13. The friction based kinesthetic actuator system of claim 11, wherein when the plurality of actuation beams are in an inactive state they are configured to not make contact with the at least one actuation surface, and wherein when the plurality of actuation beams are activated they are configured to provide a normal force against the at least one actuation surface, wherein the normal force generates the friction force.

14. The friction based kinesthetic actuator system of claim 11, wherein when the plurality of actuation beams are in an inactive state they are configured to contact the at least one actuation surface, and wherein when the plurality of actuation beams are activated they are configured to provide an increased normal force against the at least one actuation surface relative to the normal force provide when the plurality of actuation beams are in an inactive state, wherein the increased normal force generates the friction force.

15. The friction based kinesthetic actuator system of claim 11, wherein the plurality of actuation beams are configured to contact a plurality of actuation surfaces of an internal portion of the user interface element.

16. The friction based kinesthetic actuator system of claim 11, wherein the kinesthetic effect includes the friction force resisting movement of the user interface element.

17. The friction based kinesthetic actuator system of claim 11, wherein the kinesthetic effect includes a vibration effect.

18. The friction based kinesthetic actuator system of claim 17, wherein the kinesthetic effect includes the friction force generating movement of the user interface element.

19. The friction based kinesthetic actuator system of claim 11, wherein the user interface element includes an internal portion, having the at least one actuation surface, that is configured for location interior to the housing of the user interface device, and includes an external portion configured for location exterior to the housing of the user interface device, wherein the internal portion and the external portion are connected via a linkage.

20. The friction based kinesthetic actuator system of claim 19, wherein the external portion of the user interface element includes at least one of a joystick, a trigger, and a button.
